(19) United States
(12) Patent Application Publication
(10) Pub. No.: US 2018/0304649 A1
(43) Pub. Date: Oct. 25, 2018

(54) SELF-STRIP MEDIA MODULE

(71) Applicant: Datamax-O'Neil Corporation, Orlando, FL (US)

(72) Inventors: Chin Young Wong, Singapore (SG); Sébastien Michel Marie Joseph d'Armancourt, Singapore (SG); Ching Hong Chua, Singapore (SG); Yaw Horng Yap, Singapore (SG)

(21) Appl. No.: 15/939,929

(22) Filed: Mar. 29, 2018

Related U.S. Application Data
(63) Continuation of application No. 15/492,684, filed on Apr. 20, 2017, now Pat. No. 9,937,735.

(51) Int. Cl. B41J 11/04; B41J 2/32; B41J 3/407; B65C 9/00

(52) U.S. Cl. CPC B41J 11/04; B41J 2/32; B65C 2009/0093; B65C 2009/0096; B41J 3/4075

(57) ABSTRACT

A self-strip media module in a printer is provided. The self-strip media module includes a peel bar having a length at least as great as the length of a platen roller and being rotatably engaged at the ends of the platen roller. The media includes a series of labels adhered to a liner. The media is fed over the peel bar and between the platen roller and a mid-chassis. The peel bar may be rotated towards the discharge side of the platen roller, pulling the media over the platen roller and over itself. A thermal print head is lowered onto the media over the platen roller and to print on the labels. The printer advances the media over the peel bar. The labels are stripped from the liner when the media advances around the peel bar.

### CROSS-REFERENCE TO RELATED APPLICATION

The present application claims the benefit of U.S. patent application Ser. No. 15/492,684 for a Self-Strip Media Module filed Apr. 20, 2017, now U.S. Pat. No. 9,937,735. Each of the foregoing patent application and patent is hereby incorporated by reference in its entirety.

### FIELD OF THE INVENTION

The present invention relates to label printers, and more particularly to apparatus and methods to strip labels from the liner carrying the labels.

### BACKGROUND

Generally speaking, many self-strip modules for label printers come as external accessories to the printer. Thus, the label strip module would be attached when needed and not integral to the printer.

In other label printers, the self-strip module may be integral to the printer. However prior art printers with self-strip modules may not route the media to a tear bar if the self-strip module is in use. Flexibility of applications, using the self-strip or using the tear bar, is not available with the prior art label printers.

In either of these cases, the self-strip module or the printer becomes less convenient to use if flexibility is desired.

Therefore, a need exists for a self-strip module for a label printer which is integral to the printer and while providing a new path for self-stripping, also returns the media to within the printer and a tear bar, with the self-strip module not being an external module.

### SUMMARY

Accordingly, in one aspect, the present invention embraces a self-strip media module in a printer.

In an exemplary embodiment, the self-strip media module comprises a peel bar. The peel bar has a length at least as great as the length of a platen roller. The peel bar length is perpendicular to the direction in which media is being fed, or in other words, the peel bar has a length in the same direction as the platen roller length dimension. Further, the peel bar is rotatably engaged at the ends of the platen roller. The peel bar is rotatable from a first position on a discharge side of the platen roller to a second position on a feed side of the platen roller. The media is comprised of a series of labels adhered to a liner. The media is fed over the peel bar when the peel bar is in the second position. The media is then fed between the platen roller and a mid-chassis. The peel bar is configured to rotate to a third position towards the discharge side of the platen roller. The peel bar pulls the media over the platen roller and over itself. A thermal print head is configured to be lowered onto the media over the platen roller and to print on the labels. The printer is configured to advance the media over the peel bar. The labels are stripped from the liner when the media advances around the peel bar. The printer is further configured to advance the liner around the peel bar, over the platen roller, and around the platen roller after the label is printed.

In another exemplary embodiment, the media is fed between the platen roller and the mid-chassis on the feed side of the platen roller.

In another exemplary embodiment, the printer includes a liner tear bar. The liner is further fed between the platen roller and the mid-chassis on the feed side of the platen roller to the liner tear bar.

In another exemplary embodiment, the peel bar has N sides in cross-section, where N is a number greater than or equal to 3.

In yet another exemplary embodiment, the thermal print head and the media have a coefficient of friction μ₁ therein between. The media has a coefficient of friction μ₂ when pulled over itself. The media and the platen roller have a coefficient of friction μ₃ therein between. The coefficient of friction μ₃ is greater than μ₁ and greater than μ₂.

In another exemplary embodiment, the thermal print head and the media have a coefficient of friction μ₁ therein between. The media has a coefficient of friction μ₂ when pulled over itself. The media and the platen roller have a coefficient of friction μ₃ therein between. The coefficient of friction μ₃ is greater than the sum of μ₁ and μ₂.

In another exemplary embodiment, the peel bar has a longitudinally extending edge whereby the label strips from the liner as the media advances around the edge of the peel bar.

In another exemplary embodiment, the third position and the first position of the peel bar are the same position.

In another aspect, the present invention embraces a method of peeling a printed label off a liner on a media roll in a printer having a thermal print head and a platen roller.

In an exemplary embodiment, the method comprises the steps of: lifting the thermal print head off the platen roller; rotating a peel bar over the platen roller from a discharge side of the platen roller to a feed side of the platen roller; feeding media over the peel bar and between the platen roller and a mid-chassis; rotating the peel bar back over the platen roller towards the discharge side of the platen roller; replacing the thermal print head over the media and the platen roller; printing a label on the media; advancing the media over and around the peel bar; and self-stripping the label off the liner when the media advances around the peel bar.

In another exemplary embodiment, the method further comprises the step of advancing the liner to a liner tear bar on the printer.

In another exemplary embodiment of the method, the step of rotating the peel bar back over the platen roller towards the discharge side of the platen roller pulls the media with the peel bar over the platen roller.

In another aspect, the present invention embraces a self-strip media module in a printer.

In an exemplary embodiment, the self-strip media module includes a peel bar. The peel bar has a length at least as great as the length of a platen roller. The length of the peel bar is in a direction perpendicular to the direction of travel of the media. The peel bar is adapted to rotate from a first position on a discharge side of the platen roller to a second position on a feed side of the platen roller. The media is comprised of labels adhered to a liner. The media is fed over the peel bar when the peel bar is in the second position. The media is fed between the platen roller and a mid-chassis. The peel bar is configured to rotate to a third position towards the discharge side of the platen roller. The peel bar pulls the media over the platen roller and pulls the media over itself. A thermal print head is configured to be lowered onto the media over the platen roller and to print on the labels. The printer is configured to advance the media over the peel bar, the labels being stripped from the liner when the media advances around the peel bar.

In another exemplary embodiment, the peel bar is rotatably engaged at the ends of the platen roller.

In another exemplary embodiment, the printer is further configured to advance the liner around the peel bar, over the platen roller, and around the platen roller after the labels are stripped from the liner.

In another exemplary embodiment, the media is fed between the platen roller and the mid-chassis on the feed side of the platen roller.

In another exemplary embodiment, the printer includes a liner tear bar. The liner is fed between the platen roller and the mid-chassis on the feed side of the platen roller to the liner tear bar.

In yet another exemplary embodiment, the thermal print head and the media have a coefficient of friction μ₁ therein between. The media has a coefficient of friction μ₂ when pulled over itself. The liner and the platen roller have a coefficient of friction μ₃ therein between. The coefficient μ₃ is greater than μ₁ and greater than μ₂.

In another exemplary embodiment, the thermal print head and the media have a coefficient of friction μ₁ therein between. The media has a coefficient of friction μ₂ when pulled over itself. The liner and the platen roller have a coefficient of friction μ₃ therein between. The coefficient μ₃ is greater than the sum of μ₁ and μ₂.

In yet another exemplary embodiment, the first position and the third position are the same position.

In another exemplary embodiment, the peel bar has a longitudinally extending edge whereby the media strips from the liner as the liner advances around the edge of the peel bar.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 schematically depicts an exemplary embodiment of the self-strip label module in the printer before setting up the self-strip module in accordance with the present invention.

FIG. 2 schematically depicts in an exemplary embodiment of the self-strip label module the rotating the peel bar before feeding the media in the printer in accordance with the present invention.

FIG. 3 schematically depicts an exemplary embodiment of the self-strip label module where the media is routed over the peel bar in accordance with the present invention.

FIG. 4 schematically depicts in an exemplary embodiment of the self-strip label module setting the peel bar for label self-stripping.

FIG. 5 schematically depicts an exemplary embodiment of the self-strip label module showing the media path with the self-strip module in place in accordance with the present invention.

FIG. 6 schematically depicts an exemplary embodiment of the self-strip label module with the label self-stripping from the liner in accordance with the present invention.

FIG. 7 schematically depicts a side view of the media path around the self-strip module showing the friction components in the media path in an exemplary embodiment of the present invention.

FIG. 8 graphically depicts an exemplary method of self-stripping a printed label off a liner on a media roll in accordance with one aspect of the present invention.

### DETAILED DESCRIPTION

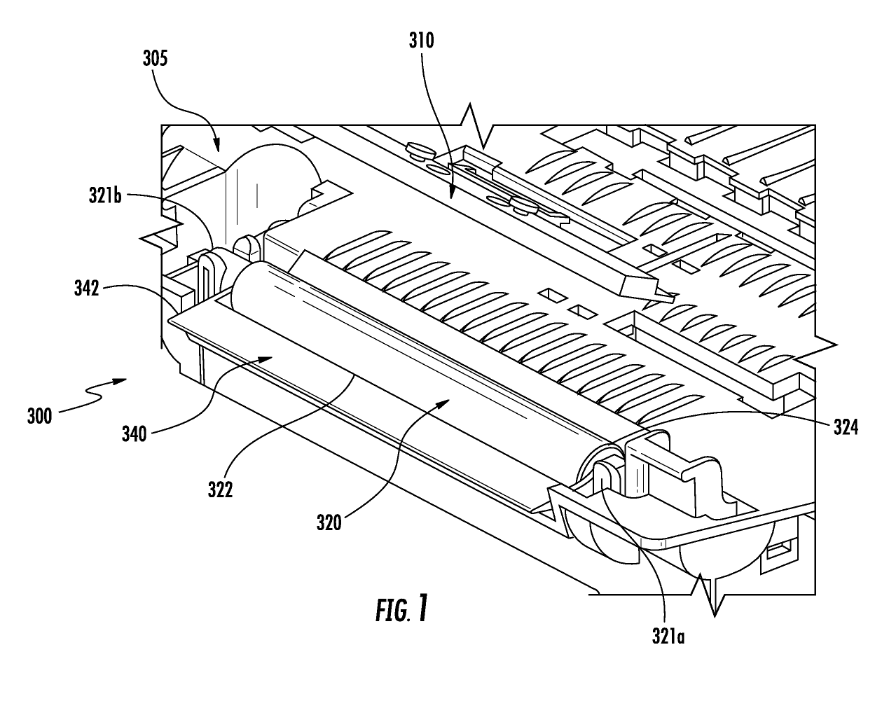

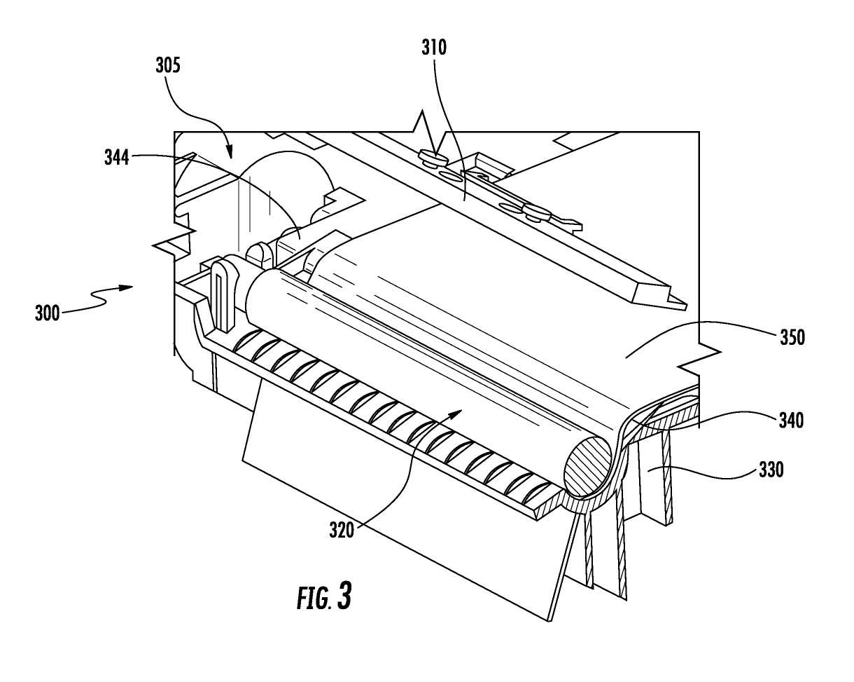

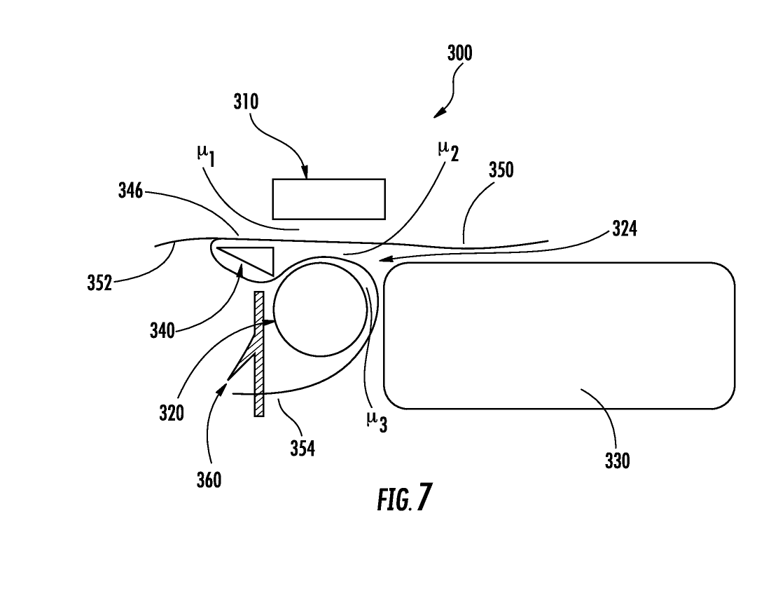

The present invention embraces a self-strip media module in a printer. Referring to FIGS. 1-6, a label printer (305) is shown in part, and generally includes a thermal print head (310), a platen roller (320), and a mid-chassis. The mid-chassis is blocked from view by other components in the present figure, but the mid-chassis (330) is depicted in FIG. 3 and FIG. 7.

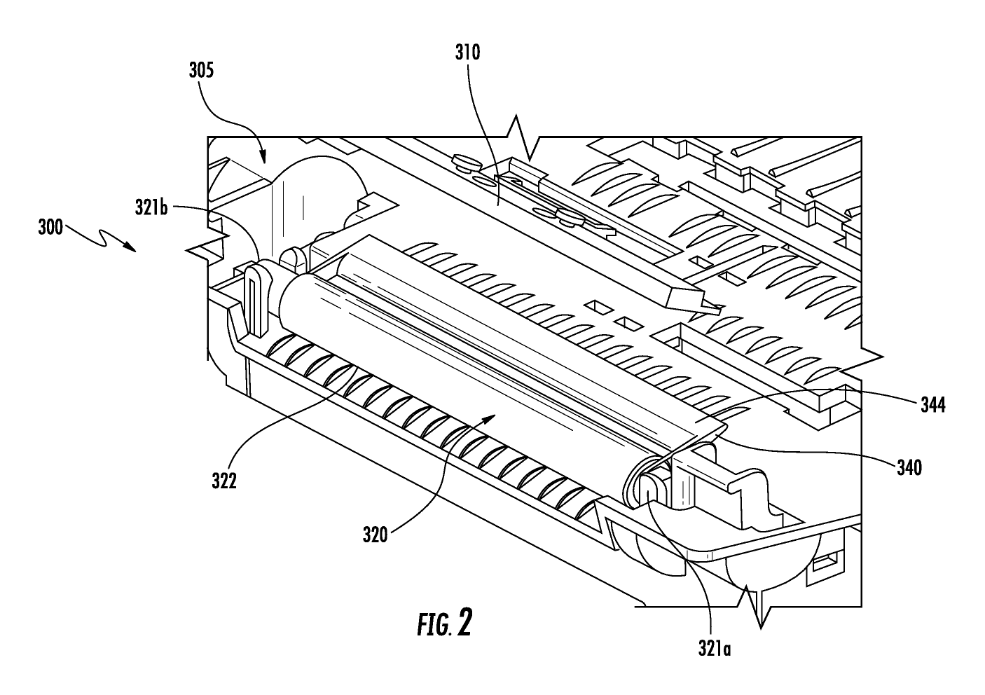

In an exemplary embodiment depicted in FIG. 1, the self-strip module (300) is comprised of a peel bar (340). The peel bar (340) has a length, or a long dimension, at least as great as the length, or the long dimension of the platen roller (320). The length dimension of the peel bar (340) is perpendicular to the direction of travel of the media in the printer (305). As shown, the peel bar (340) is rotatably engaged at the ends (321a and 321b) of the platen roller (320). The peel bar (340) is rotatable from a first position (342) on a discharge side (322) of the platen roller (320) to, see FIG. 2, a second position (344) on a feed side (324) of the platen roller (320). While the Figures show the peel bar (340) rotatably engaged at the ends (321a and 321b) of the platen roller (320), other arrangements for rotating the peel bar (320) from the first position (342) to the second position (344) are possible as would be known by those skilled in the art. For example, the pivot points for the peel bar (340) while necessarily being outside the long dimension of the platen roller (320) can be separate from the platen roller (320).

The thermal print head (310) is shown lifted off the platen roller (320) in order to rotate the peel bar (340) in the quick set up of the self-strip module.

Referring now to FIG. 3, which depicts the self-strip module (300) of FIG. 1 and FIG. 2 with label media added.

In the FIG. 3, parts of the printer (305) at the (321a) end of the platen roller (320) are not shown in order to clearly see the media path and the mid-chassis (330). The media (350) is comprised of a series of labels adhered to a liner. For simplicity and clarity, the labels and liner are not distinguishable from each other in the present FIG. 3. The media (350) is fed over the peel bar (340) when the peel bar (340) is in the second position (344). The media (350) is fed between the platen roller (320) and the mid-chassis (330). The thermal print head (310) remains lifted off the platen roller (320).

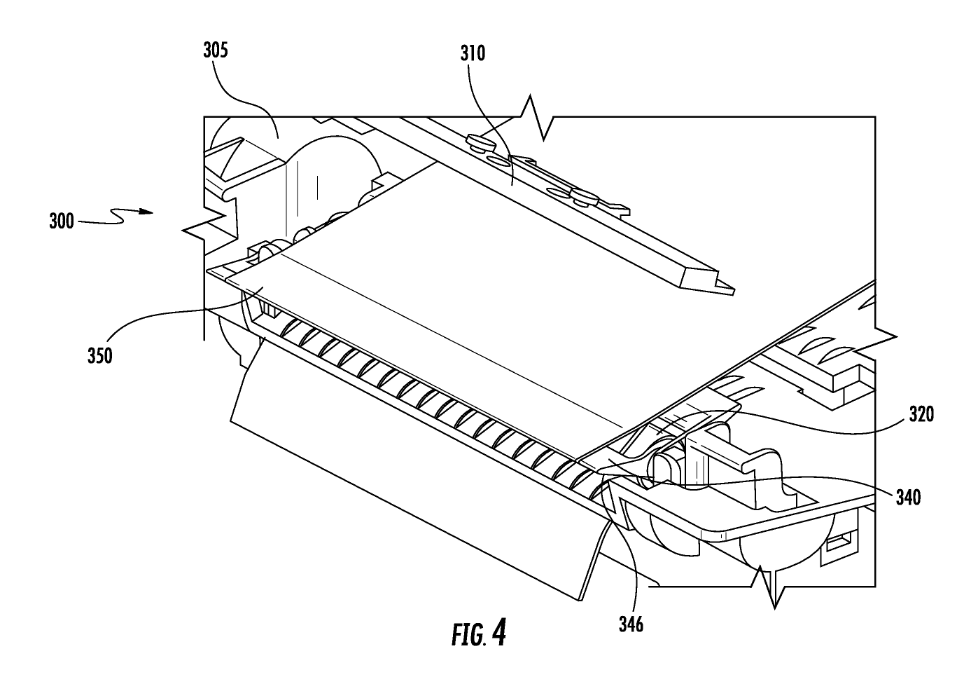

Referring now to FIG. 4, continuing the setup of the self-strip module (300), the peel bar (340) is configured to rotate to a third position (346) towards the discharge side (not clearly visible in the present Figure) of the platen roller (320). When rotated to third position (346), the peel bar (340) pulls the media (350) over the platen roller (320) and over itself (350).

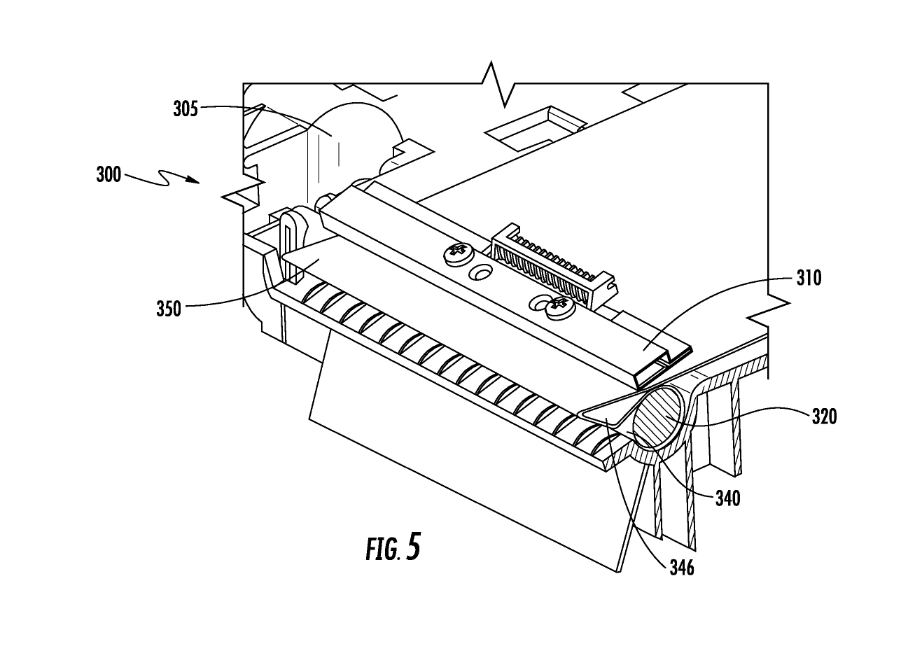

Referring now to FIG. 5, continuing the setup of the self-strip module (300), the thermal print head (310) is lowered onto the media (350) on the platen roller (320). The thermal print head (310) is configured to print on the labels, while the printer (305) is configured to advance the media (350).

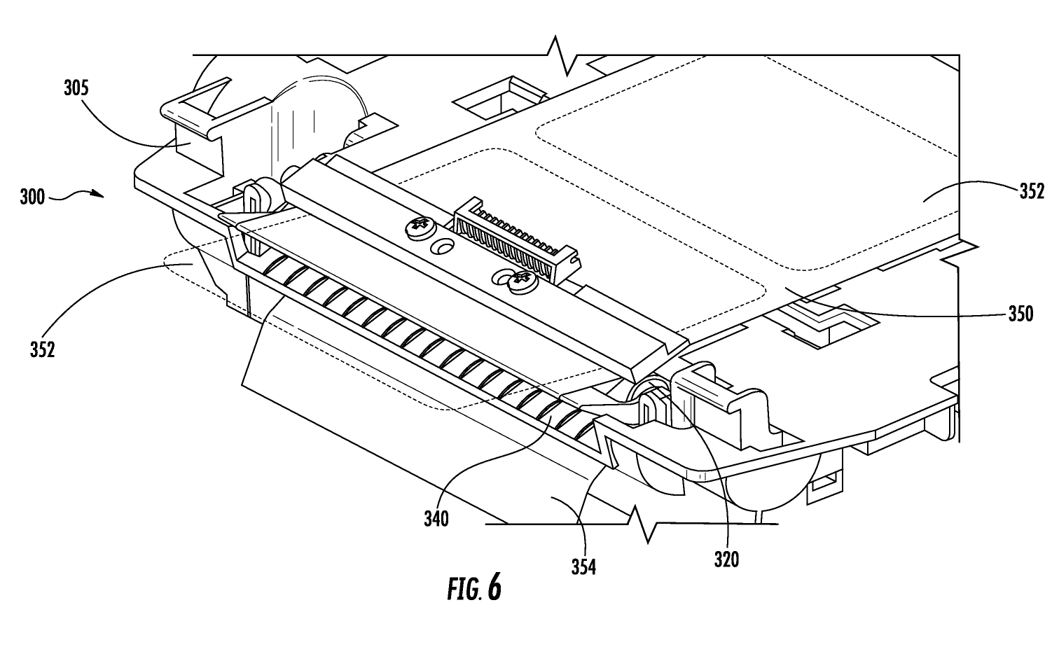

Referring to FIG. 6, the labels (352) and the liner (354) are now shown as distinguishable portions of the media (350). As the media (350) is advanced by the printer (305) over the peel bar (340) in the third position (346), the labels (352) are stripped from the liner (354) as the media (350) advances around the peel bar (340). The printer (305) is configured to advance the remaining liner (354) around the peel bar (340), over the platen roller (320), and around the platen roller (320) as shown by the media path in FIG. 5 and FIG. 6.

The peel bar (340) is shown in all the Figures as a flat bar with a longitudinally extending edge, whereby the media (350) is advanced around the longitudinally extending edge to self-strip the labels (352). However, in another exemplary embodiment, the peel bar may have more than 2 longitudinally extending edges. A multi-sided peel bar, for example 3 or more sides in cross-section, is appropriate based upon the sides have longitudinally extending edges whereby the label will strip from the liner as the media is advanced around the peel bar. As the number of sides of the peel bar increases, the effectiveness of the self-strip separation of the label from the liner decreases.

In the FIGS. 1-6, the first position (342) and the third position (346) of the peel bar (340) are shown as distinct from each other. In another exemplary embodiment, the first position and third position may be the same position. That is, when rotating the peel bar (340) towards the discharge side (322) of the platen roller (320), the peel bar (340) rotates the entire rotation to the first position (342). During this rotation, the peel bar (340) pulls the media (350) over the platen roller (320) and over itself (350).

Referring now to FIG. 7, the self-strip module (300) is shown in a side view in order to clearly depict the friction components on the media path. Connection points between components are omitted and contact points are expanded so that the media path and friction points are clearly visible. As shown in the previous Figures, after the peel bar (340) is set to the third position (346), the media (350) passes over itself and under the thermal print head (310). The media (350) passes around the peel bar (340) and around the platen roller (320) to the liner tear bar (not shown). The thermal print head (310) and the media (350) have a coefficient of friction μ₁ therein between. The media (350) has a coefficient of friction μ₂ when pulled over itself. The media (350) and the platen roller (320) have a coefficient of friction μ₃ therein between. The coefficient of friction, μ₃, between the media (350) and the platen roller (320) is greater than μ₁ and greater than μ₂. In an exemplary embodiment, the coefficient of friction, μ₃, between the media (350) and the platen roller (320) is greater than the sum of μ₁ and μ₂.

Continuing in FIG. 7 is shown an exemplary embodiment where the printer (305) may be further equipped with a liner tear bar (360). The liner (354) is fed between the platen roller (320) and the mid-chassis (330) on the feed side (324) of the platen roller (320) to the liner tear bar (360).

The present invention satisfies the object of the invention because the media path, while new in that it brings the media to the self-strip module, requires the media to stay within the printer, whereas prior art devices and method give a path for the media to an external module.

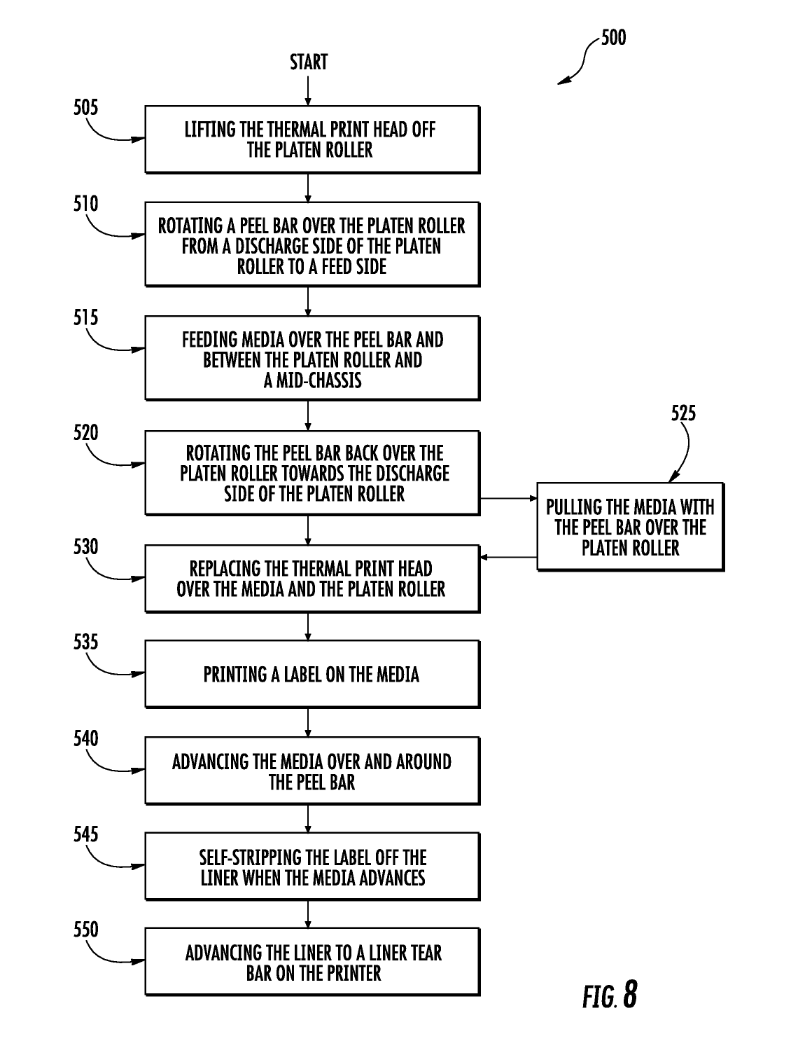

The present invention also embraces a method of self-stripping or peeling a printed label off a liner on a media roll in a printer having a thermal print head and a platen roller. Referring now to FIG. 8, an exemplary embodiment of the method (500) is schematically depicted with steps comprising: (505) lifting the thermal print head off the platen roller; (510) rotating a peel bar over the platen roller from a discharge side of the platen roller to a feed side of the platen roller; (515) feeding media over the peel bar and between the platen roller and a mid-chassis; (520) rotating the peel bar back over the platen roller towards the discharge side of the platen roller; (530) replacing the thermal print head over the media and the platen roller; (535) printing a label on the media; (540) advancing the media over and around the peel bar; and (545) self-stripping the label off the liner when the media advances around the peel bar.

The step (520) rotating the peel bar back over the platen roller towards the discharge side of the platen roller, includes the step (525) of pulling the media with the peel bar over the platen roller.

The (545) self-stripping step is accomplished with a peel bar having an edge at the position where the media is advanced around the peel bar, whereby the label self-strips and does not advance around the peel bar, but the liner does advance around the peel bar.

The method (500) may further include the step of (550) advancing the liner to a liner tear bar on the printer. The liner can be torn at the liner tear bar.

The FIGS. 1-7 may be advantageously viewed in conjunction with the method (500) of the present embodiment.

To supplement the present disclosure, this application incorporates entirely by reference the following commonly assigned patents, patent application μublications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A module, comprising:
a peel bar rotatable from a first position on a discharge side of a platen roller to a second position on a feed side of the platen roller and to a third position on the discharge side of the platen roller;
wherein, when the peel bar is in the second position, media is fed over the peel bar and between the platen roller and a mid-chassis of a printer;
wherein, when the peel bar is rotated from the second position to the third position after the media is fed over the peel bar and between the platen roller and the mid-chassis, the peel bar pulls the media over the platen roller and over itself;
wherein the printer comprises a thermal printhead configured to be lowered onto the media over the platen roller and to print on media, the media comprising a series of labels adhered to a liner; and
wherein, when the printer advances the media over the peel bar when the peel bar is in the third position, the labels are stripped from the liner as the media advances around the peel bar and the printer advances the liner around the peel bar and over the platen roller.

2. The module of claim 1, wherein the media is fed between the platen roller and the mid-chassis on the feed side of the platen roller.

3. The module of claim 1, wherein the liner is fed between the platen roller and the mid-chassis on the feed side of the platen roller.

4. The module of claim 1, wherein the peel bar has N sides in cross-section, where N is a number greater than or equal to 3.

5. The module of claim 1, wherein:
the thermal print head and the media have a coefficient of friction μ1 therein between;
the media has a coefficient of friction μ2 when pulled over itself;
the media and the platen roller have a coefficient of friction μ3 therein between;
μ3 is greater than μ1; and
μ3 is greater than μ2.

6. The module of claim 1, wherein:
the thermal print head and the media have a coefficient of friction μ1 therein between;
the media has a coefficient of friction μ2 when pulled over itself;
the media and the platen roller have a coefficient of friction μ3 therein between; and
μ3 is greater than the sum of μ1 and μ2.

7. The module of claim 1, wherein the peel bar has a longitudinally extending edge whereby the label strips from the liner as the media advances around the edge of the peel bar.

8. The module of claim 1, wherein the peel bar is rotatable about pivot points separate from the platen roller.

9. A method, comprising:
rotating a peel bar over the platen roller from a discharge side of the platen roller to a feed side of the platen roller;
feeding media over the peel bar and between the platen roller and a mid-chassis, the media comprising a series of labels and a liner;
rotating the peel bar back over the platen roller towards the discharge side of the platen roller;
lowering a thermal print head over the media and the platen roller;
printing on a label of the media;
advancing the media over and around the peel bar; and
stripping the printed label off the liner when the media advances around the peel bar.

10. The method of claim 9, comprising advancing the liner to a liner tear bar on the printer.

11. The method of claim 9, wherein the step of rotating the peel bar back over the platen roller towards the discharge side of the platen roller comprises pulling the media with the peel bar over the platen roller.

12. A module, comprising:
a peel bar rotatable from a first position on a discharge side of a platen roller to a second position on a feed side of the platen roller and to a third position on the discharge side of the platen roller;
wherein, when the peel bar is in the second position, media is fed over the peel bar and between the platen roller and a mid-chassis of a printer;
wherein, when the peel bar is rotated from the second position to the third position after the media is fed over the peel bar and between the platen roller and the mid-chassis, the peel bar pulls the media over the platen roller and over itself;
wherein the printer comprises a thermal printhead configured to be lowered onto the media over the platen roller and to print on labels, the media comprising a series of labels adhered to a liner; and
wherein, when the printer advances the media over the peel bar when the peel bar is in the third position, the labels are stripped from the liner as the media advances around the peel bar.

13. The module of claim 12, wherein the peel bar is rotatably engaged at the ends of the platen roller.

14. The module of claim 12, wherein the printer is configured to advance the liner around the peel bar, over the platen roller, and around the platen roller after the labels are stripped from the liner.

15. The module of claim 12, wherein the media is fed between the platen roller and the mid-chassis on the feed side of the platen roller.

16. The module of claim 12, wherein: the liner is fed between the platen roller and the mid-chassis on the feed side of the platen roller.

17. The module of claim 12, wherein:
the thermal print head and the media have a coefficient of friction μ1 therein between;
the media has a coefficient of friction μ2 when pulled over itself;
the media and the platen roller have a coefficient of friction μ3 therein between;
μ3 is greater than μ1; and
μ3 is greater than μ2.

18. The module of claim 12, wherein:
the thermal print head and the media have a coefficient of friction μ1 therein between;
the media has a coefficient of friction μ2 when pulled over itself;
the media and the platen roller have a coefficient of friction μ3 therein between; and
μ3 is greater than the sum of μ1 and μ2.

19. The module of claim 12, wherein the peel bar is rotatable about pivot points separate from the platen roller.

20. The module of claim 12, wherein the peel bar has more than two longitudinally extending edges.
